(19) United States
(12) Patent Application Publication
(10) Pub. No.: US 2002/0100338 A1
(43) Pub. Date: Aug. 1, 2002

(54) Eccentric assembly with eccentric weight and biased counterweight

(75) Inventor: Vern E. Martin, Shippensburg, PA (US)

Correspondence Address: MICHAEL BEST & FRIEDRICH, LLP, 100 E WISCONSIN AVENUE, MILWAUKEE, WI, 53202, US

(73) Assignee: Ingersoll-Rand Company, Shippensburg, PA (US)

(21) Appl. No.: 09/771,817

(22) Filed: Jan. 29, 2001

(51) Int. Cl. F16H 33/10; F16H 37/00

(52) U.S. Cl. 74/87

(57) ABSTRACT

The eccentric assembly includes a shaft, an eccentric weight, and a counterweight. The eccentric weight is mounted on the shaft such that as a motor rotates the shaft, the eccentric weight generates vibrations that are transferred to the drum assembly of the vibration compacting machine. The eccentric assembly also includes a counterweight that is coupled to the eccentric weight. The counterweight moves between a first position where a first surface on the counterweight contacts a second surface on the eccentric weight and a second position where the first surface of the counterweight is separated from the second surface of the eccentric weight. One of the entire first or second surfaces engages the other of the first surface or second surface when the eccentric weight and the counterweight are in the first position.

### FIELD OF THE INVENTION

This invention relates to vibration compacting machines, and more particularly to an eccentric assembly for a vibration compacting machine.

### BACKGROUND OF THE INVENTION

Vibration compacting machines are used in leveling paved or unpaved ground surfaces. A typical vibration compacting machine includes an eccentric assembly for generating vibrations that are transferred to a drum assembly of the compacting machine. The eccentric assembly commonly includes one or more eccentric weights that are adjustable between a plurality of discrete radial positions relative to the shaft in order to vary the amplitude of the vibrations that are generated by rotating the eccentric weight(s) about the shaft.

The eccentric weight(s) that are used in conventional eccentric assemblies are often adjustable. One such device is operable between a first mode that creates a high amplitude vibration and a second mode that creates a low amplitude vibration. The device includes a plurality of eccentric weights that are fixed to the shaft and a corresponding number of counterweights that are coupled to the opposite side of the shaft relative to the eccentric weight. The counterweights are moveable between a retracted position and a projected position relative to the longitudinal axis of the shaft. When the counterweights are in the retracted position their effect on the eccentric weights is minimized resulting in maximum vibration amplitude being generated by the eccentric weights. The counterweights are normally biased toward the retracted position, however as the shaft rotates the biasing force is overcome and the counterweights are moved to the projected position where the counterweights are further away from the shaft. As the counterweights move further from the shaft, the counterweights reduce the effect of the eccentric weights resulting in a lower vibration amplitude.

One type of adjustable eccentric assembly operates by varying the rotational speed of the shaft. The eccentric assembly includes one or more eccentric weights that are biased toward the shaft. During operation of the eccentric assembly the shaft rotates, and as the rotational speed of the shaft increases, a centrifugal force overcomes the biasing force and causes the eccentric weight to move away from the shaft. The vibration amplitude increases as the eccentric weights move away from the shaft.

The above-described eccentric assemblies are generally effective for creating vibrations within the drum assemblies of vibration compacting machines. Therefore, any improvement to such eccentric assemblies would be desirable.

### SUMMARY OF THE INVENTION

The present invention is directed to an eccentric assembly for a vibration compacting machine. Rotating the eccentric assembly generates vibrations that are transferred to the drum assembly of the vibration compacting machine.

The eccentric assembly of the present invention generates vibrations that have a lower amplitude at high rotational speeds (i.e., frequencies). Reducing vibration amplitude at higher shaft speeds minimizes wear to each of the load bearing components in the vibration compacting machine resulting in an extended service life for the vibration compacting machine. The eccentric assembly of the present invention is also (i) easily and inexpensively manufactured; (ii) preferably machined from a single piece of material; and (iii) readily adapted to be used in existing vibration compacting machines.

The eccentric assembly includes a shaft, an eccentric weight, and a counterweight. The eccentric weight is mounted on the shaft such that as a motor rotates the shaft, the eccentric weight generates vibrations that are transferred to the drum assembly of the vibration compacting machine. The eccentric assembly also includes a counterweight that is coupled to the eccentric weight. The counterweight moves between a first position where a first surface on the counterweight contacts a second surface on the eccentric weight and a second position where the first surface of the counterweight is separated from the second surface of the eccentric weight. One of the entire first or second surfaces engages the other of the first surface or second surface when the eccentric weight and the counterweight are in the first position.

During operation of the vibration compacting machine, the eccentric assembly generates a maximum moment of eccentricity about the shaft when the counterweight is in contact with the eccentric weight (i.e., the first position). As the rotational speed of the shaft increases, the eccentric weight and the counterweight are separated and the moment of eccentricity generated by rotating the shaft decreases.

The counterweight is preferably biased toward the first position by a spring. The counterweight will remain in the first position until the shaft is rotated at a high enough speed to create a centrifugal force on the counterweight that overcomes the biasing force generated by the spring. Once the centrifugal force is larger than the biasing force, the counterweight moves toward the second position thereby lowering the moment of eccentricity and decreasing the vibration amplitude.

Other features and advantages of the invention will become apparent to those skilled in the art upon review of the following detailed description, claims, and drawings.

### BRIEF DESCRIPTION OF THE DRAWINGS

FIG. 1 is a perspective view of a vibration compacting machine that includes an eccentric assembly of the present invention.

FIG. 2 is a section view of a drum assembly of the vibration compacting machine illustrated in FIG. 1 taken along line 2-2.

FIG. 3 is an enlarged perspective view of the eccentric assembly illustrated in FIG. 2.

FIG. 4 is a section view taken along line 4-4 in FIG. 2, illustrating the eccentric assembly in a static condition.

FIG. 5 is a section view similar to FIG. 4, illustrating the eccentric assembly in a dynamic condition.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

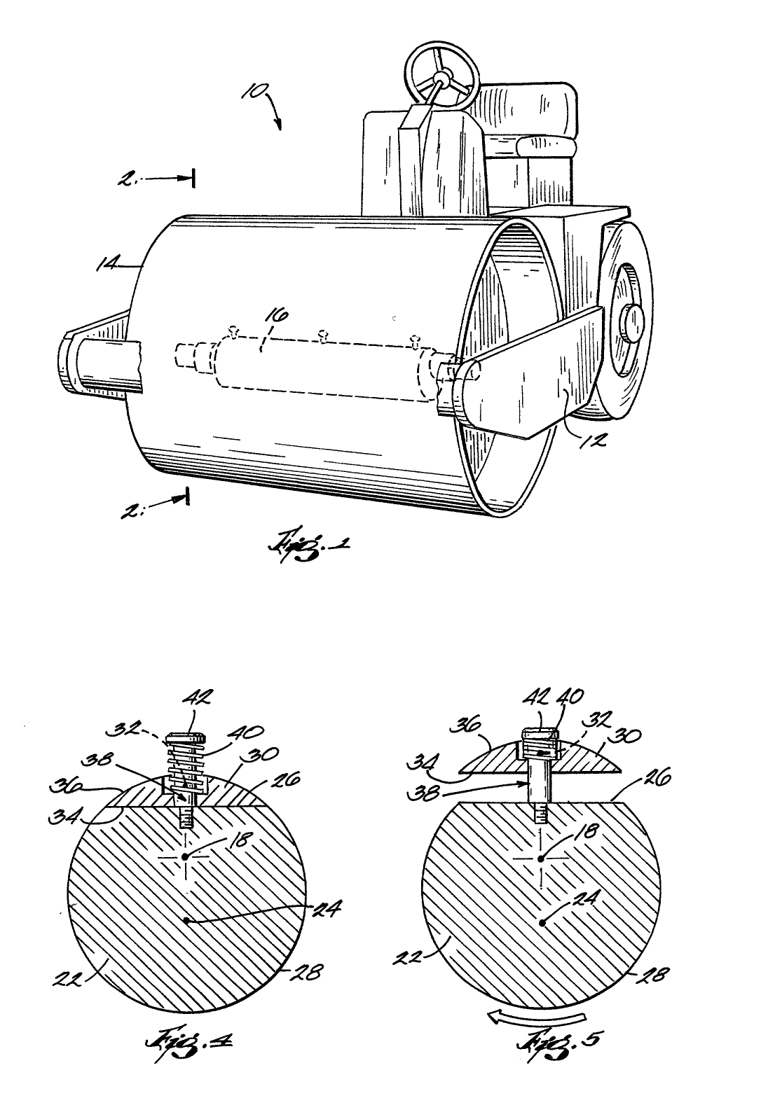

FIG. 1 illustrates a vibration compacting machine 10 according to the present invention. The vibration compacting machine 10 is used in leveling paved or unpaved ground surfaces. The vibration compacting machine 10 includes a frame 12 and a drum assembly 14 mounted to the frame 12 for rotation about a longitudinal axis 13.

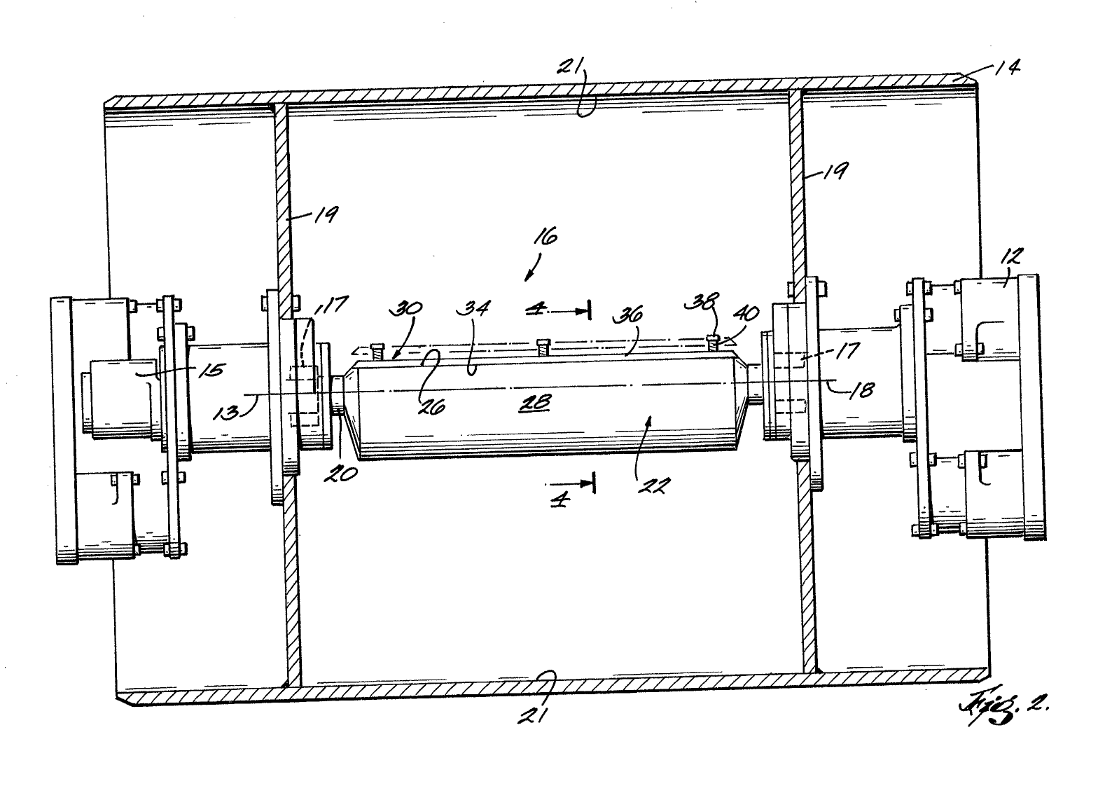

Referring now also to FIG. 2, the drum assembly 14 includes an eccentric assembly 16 that is mounted for rotation relative to a drum 21 within the drum assembly 14. The eccentric assembly 16 rotates about an axis of rotation 18 that is substantially aligned with the longitudinal axis 13 of the drum assembly 14. The eccentric assembly 16 includes a moment of eccentricity such that rotation of the eccentric assembly 16 by a motor 15 creates vibrations that are transferred to the drum 21 and drum assembly 14 of the vibration compacting machine 10.

The eccentric assembly 16 includes a shaft 20 that is mounted at each end to bearings 17 (shown only in FIG. 2). The bearings 17 are secured to parallel supports 19 that extend across the inner diameter of the drum 21. The supports 19 are welded to an interior wall of the drum 21 and are generally perpendicular to the longitudinal axis 13 of the drum 21. The motor 15 rotates the shaft 20 about the axis of rotation 18 such that the eccentric assembly 16 generates vibrations.

The eccentric assembly 16 also includes an eccentric weight 22 that is mounted to the shaft 20 such that a center of gravity 24 of the eccentric weight 22 is located to one side of the axis of rotation 18. The eccentric weight 22 is preferably cylindrically-shaped and extends along the length of the shaft 20.

The eccentric weight 22 includes a first surface 26 that is located on an opposite side of the axis of rotation 18 from the center of gravity 24. The eccentric weight 22 also includes an outside surface 28 that substantially defines the cylindrical shape of the eccentric weight 22. The first surface 26 is preferably planar and extends the length of the eccentric weight 22. The planar first surface 26 is preferably substantially parallel with the axis of rotation 18 of the shaft 20.

The eccentric assembly 16 also includes a counterweight 30 that is slidably mounted to the eccentric weight 22 such that a center of gravity 32 of the counterweight 30 is located on the opposite side of the axis of rotation 18 from the center of gravity 24 of the eccentric weight 22. The counterweight 30 is preferably semi-cylindrical and extends along the length of the shaft 20.

The counterweight 30 includes (i) a second surface 34 that is located on the same side of the axis of rotation 18 as its center of gravity 32; and (ii) an outside surface 36 that substantially defines a semi-cylindrical shape of the counterweight 30. The second surface 34 is preferably planar and extends along the length of the counterweight 30 such that the plane defined by the second surface 34 is substantially parallel with the axis of rotation 18 and the planar first surface 26 of the eccentric weight 22.

The shaft 20, the eccentric weight 22, and the counterweight 30 are preferably manufactured from the same piece of material, and even more preferably, the shaft 20 is integral with the eccentric weight 22. The shaft 20 and the outside surfaces 28, 36 of the eccentric weight 22 and the counterweight 30 are machined on a lathe from a single piece of material and then the counterweight 30 is cut from the eccentrically weighted shaft. In an alternative form, the counterweight 30 and eccentric weight 22 are fabricated in multiple pieces.

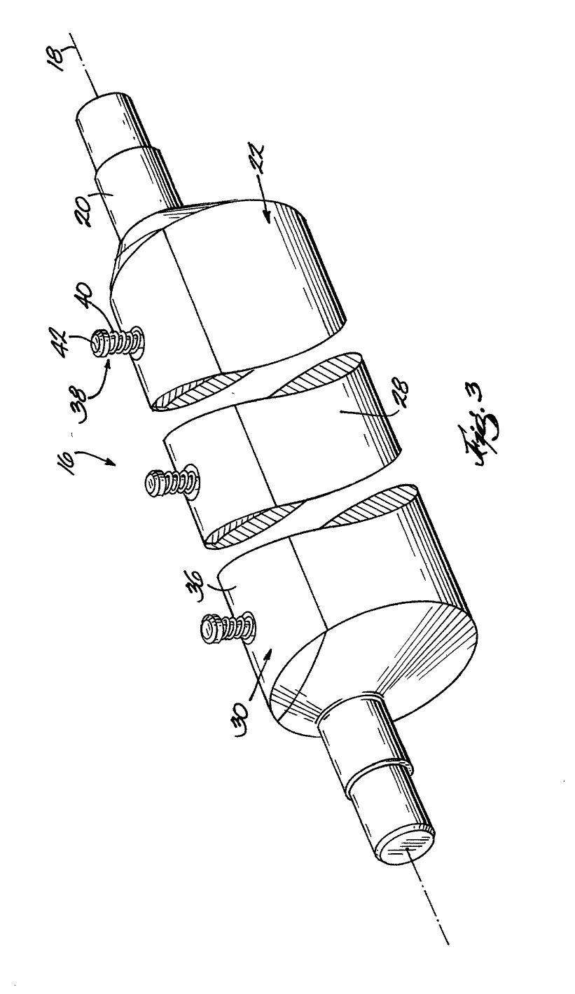

The counterweight 30 is moveable from a first position (FIG. 4) where the second surface 34 of the counterweight 30 is in contact with the first surface 26 of the eccentric weight 22, and a second position (FIG. 5) where the second surface 34 is separated from the first surface 26. The entire first surface 26 contacts the entire second surface 34 over the entire length of the shaft. Since the eccentric weight 22 and the counterweight 30 are manufactured from the same piece of stock, the slope of the outside surface 36 on the counterweight 30 that is adjacent to the second surface 34 is approximately equal to the slope of the outside surface 28 on the eccentric weight 22 that is adjacent to the first surface 26. It should be understood that only one of the entire first surface 26 or second surface 34 may be in contact with the other surface without departing from the scope of the present invention.

The eccentric assembly 16 includes at least one post 38 that is coupled to the eccentric weight 22, and a coil spring 40 that is located around each post 38. The eccentric assembly 16 preferably includes multiple posts 38 that are equally spaced over the length of the eccentric weight 22 and extend perpendicularly from the first surface 26 of the eccentric weight 22. The counterweight 30 is slidably coupled to the posts 38 and biased toward the first position by the springs 40. The posts 38 each include a spring retainer 42 on one end to (i) maintain the spring 40 around the post 38; and (ii) bias the counterweight 30 against the eccentric weight 22. The posts 38 preferably extend toward the centers of gravity 24 of the eccentric weight 22 and the counterweight 30.

During operation of the eccentric assembly 16, the shaft 20 begins at rest such that the eccentric weight 22 and the counterweight 30 are in the first position (FIG. 4) with the biasing force of the springs 40 maintaining the second surface 34 of the counterweight 30 against the first surface 26 the eccentric weight 22. When the first and second surfaces 26, 34 are in contact, the eccentric assembly 16 has a maximum moment of eccentricity. As the motor 15 begins rotating the shaft 20, the eccentric weight 22 generates vibrations which are transferred to the drum assembly 14 of the vibration compacting machine 10. The eccentric assembly 16 operates in either direction of rotation, however it is a performance advantage in having the rotational direction of the shaft 20 coincide with the traveling direction of the vibration compacting machine 10.

Rotating the shaft 20 generates a centrifugal force on the counterweight 30 that urges the counterweight 30 to move away from the axis of rotation 18 and the eccentric weight 22. When the shaft 20 rotates at a high enough speed, the centrifugal force acting on the counterweight 30 overcomes the biasing force provided by the springs 40 such that the counterweight 30 compresses the springs 40 and slides along the posts 38 away from the first position. As the counterweight 30 moves away from the axis of rotation 18, the counterweight 30 further offsets the moment of eccentricity created by the eccentric weight 22. As the speed of the shaft 20 continues to increase, the counterweight 30 eventually moves a maximum distance away from the eccentric weight 22 (FIG. 5). It should be noted that the posts 38 may be extended to provide an increased distance of travel for the counterweight 30. When the counterweight 30 is the maximum distance from the eccentric weight 22, the eccentric assembly 16 has a minimum moment of eccentricity.

Lower moments of eccentricity about the shaft 20 causes the shaft 20 to transfer lower vibration amplitudes. Therefore, the vibration amplitude generated by the eccentric assembly 16 in the second position is smaller than the vibration amplitude that is generated when the counterweight 30 is in the first position. The lower vibration amplitude at increased vibration frequencies reduces bearing wear and extends the bearing life because smaller vibration amplitudes are obtained at the higher shaft 20 rotation speeds.

Reducing the rotation speed of the shaft 20 decreases the centrifugal force acting on the counterweight 30 such that the biasing force of the spring 40 overcomes the centrifugal force acting on the counterweight 30. This biasing force moves the counterweight 30 back toward the first position thereby increasing the moment of eccentricity of the eccentric assembly 16 until the biasing force of the spring 40 returns the counterweight 30 to the first position.

What is claimed is:

1. An eccentric assembly for a vibration compacting machine, the eccentric assembly comprising:
a shaft rotatably mounted to a drum assembly on the vibration compacting machine, the shaft being rotatable about an axis;
an eccentric weight coupled to the shaft, the eccentric weight including a center of gravity on a first side of the axis and a first surface on a second side of the axis that is opposite to the first side; and
a counterweight coupled to the eccentric weight, the counterweight including a center of gravity and a second surface on the second side of the axis, wherein one of the entire first surface or second surface engages the other of the first surface or the second surface.

2. The eccentric assembly of claim 1, wherein the second surface on the counterweight engages the first surface on the eccentric weight until the shaft rotates at a desired speed.

3. The eccentric assembly of claim 1, wherein the size of the first surface on the eccentric weight is approximately equal to the size of the second surface on the counterweight.

4. The eccentric assembly of claim 1, wherein the first surface on the eccentric weight and the second surface on the counterweight extend approximately the same length along the shaft.

5. The eccentric assembly of claim 1, wherein the first surface on the eccentric weight and the second surface on the counterweight are substantially planar.

6. The eccentric assembly of claim 1, wherein the counterweight includes a rounded outside surface and the eccentric weight includes a rounded outside surface.

7. The eccentric assembly of claim 6, wherein the slope of the outside surface on the counterweight that is adjacent to the second surface is approximately equal to the slope of the outside surface on the eccentric weight that is adjacent to the first surface.

8. The eccentric assembly of claim 1, wherein the counterweight is slidably coupled to the eccentric weight and moveable between a first position where the first surface on the eccentric weight engages the second surface on the counterweight and a second position where the first surface on the eccentric weight is separated from the second surface on the counterweight.

9. The eccentric assembly of claim 8, wherein the counterweight is biased toward the first position.

10. The eccentric assembly of claim 9, wherein the counterweight is biased toward the first position by a spring.

11. The eccentric assembly of claim 10, wherein rotating the shaft at a sufficient speed creates a centrifugal force on the counterweight that overcomes the biasing force and moves the counterweight from the first position to the second position.

12. The eccentric assembly of claim 10, further comprising a post coupled to the eccentric weight, wherein the counterweight is slidably coupled to the post and biased toward the first position by a spring positioned around the post.

13. The eccentric assembly of claim 12, wherein the post extends generally perpendicularly from the first surface on the eccentric weight.

14. The eccentric assembly of claim 13, wherein the post extends through the shaft.

15. The eccentric assembly of claim 14, wherein the post extends through the center of gravity of the eccentric weight.

16. The eccentric assembly of claim 15, wherein the post extends through the center of gravity of the counterweight.

17. The eccentric assembly of claim 1, wherein the counterweight includes multiple pieces.

18. The eccentric assembly of claim 1, wherein the eccentric weight includes multiple pieces.

19. The eccentric assembly of claim 1, wherein the eccentric weight is integrally formed with the shaft.

20. The eccentric assembly of claim 1, wherein the eccentric weight and the counterweight are made from the same piece of material.

21. An eccentric assembly for a vibration compacting machine, the eccentric assembly comprising:
a shaft rotatably mounted to a drum assembly on the vibration compacting machine, the shaft being rotatable about an axis;
an eccentric weight coupled to the shaft, the eccentric weight including a center of gravity on a first side of the axis and a first surface on a second side of the axis that is opposite to the first side;
a counterweight coupled to the eccentric weight, the counterweight including a center of gravity and a second surface on the second side of the axis, wherein one of the entire first surface or second surface engages the other of the first surface or second surface.
a post extending from the first surface of the eccentric weight, the counterweight being slidably connected to the post; and
a spring positioned around the post, the spring biasing the counterweight toward the eccentric weight.

22. An eccentric assembly for a vibration compacting machine, the eccentric assembly comprising:
a shaft rotatably mounted to a drum assembly on the vibration compacting machine, the shaft being rotatable about an axis;
an eccentric weight coupled to the shaft, the eccentric weight including a center of gravity on a first side of the axis and a first surface on a second side of the axis that is opposite to the first side such that rotation of the shaft creates an eccentric moment about the shaft to generate vibrations that are transferred to the drum assembly on the vibration compacting machine; and
a counterweight slidably coupled to the eccentric weight, the counterweight including a center of gravity and a second surface on the second side of the axis, wherein the eccentric weight is moveable between a first position where one of the entire first surface or second surface engages the other of the first surface or second surface such that the eccentric assembly generates a maximum eccentric moment about the shaft, and a second position where as shaft rotation speed increases the first surface on the eccentric weight is separated from the second surface on the counterweight thereby decreasing the eccentric moment generated by the eccentric assembly.
